(19) United States
(12) Patent Application Publication
(10) Pub. No.: US 2026/0275777 A1
(43) Pub. Date: Sep. 17, 2026

(54) LOCK SYSTEM FOR RECREATIONAL VEHICLE

(71) Applicant: Textron Inc., Providence, RI (US)

(72) Inventors: Matthew Francis Simms, Augusta, GA (US); Joel Enrique Pabon, North Augusta, SC (US); Mia Sharese Abney, Evans, GA (US)

(73) Assignee: Textron Inc., Providence, RI (US)

(21) Appl. No.: 19/079,038

(22) Filed: Mar. 13, 2025

(51) Int. Cl. E05B 81/56; B60R 5/02; B60R 5/04; B60R 7/04; B60R 7/06; E05B 83/18; E05B 83/24; E05B 83/30

(52) U.S. Cl. CPC E05B 81/56; B60R 5/02; B60R 5/04; B60R 7/043; B60R 7/06; E05B 83/18; E05B 83/24; E05B 83/30

(57) ABSTRACT

A recreational vehicle includes a chassis, a body coupled to the chassis and having an occupant portion, a storage compartment defining a storage volume, a lock configured to selectively transition between a locked configuration and an unlocked configuration, wherein, in the locked configuration, access to the storage volume is inhibited, and, in the unlocked configuration, access to the storage volume is permitted, and one or more processing circuits configured to receive an unlock signal from an external device, generate an unlock command based on the unlock signal, receive a lock signal, and generate a lock command based on the lock signal. In response to the unlock command being generated, the lock is configured to transition to the unlocked configuration. In response to the lock command being generated, the lock is configured to transition to the locked configuration while maintaining access to the occupant portion of the body.

### BACKGROUND

Recreational vehicles such as golf carts, drink carts, ground maintenance vehicles, utility vehicles, etc. are commonly used by operators to navigate between locations such as around a golf course, around a neighborhood, etc.

### SUMMARY

One embodiment relates to a recreational vehicle. The recreational vehicle includes a chassis, a body coupled to the chassis and having an occupant portion, a storage compartment defining a storage volume, a lock configured to selectively transition between a locked configuration and an unlocked configuration, wherein, in the locked configuration, access to the storage volume is inhibited, and, in the unlocked configuration, access to the storage volume is permitted, and one or more processing circuits configured to receive an unlock signal from an external device, generate an unlock command based on the unlock signal, receive a lock signal, and generate a lock command based on the lock signal. In response to the unlock command being generated, the lock is configured to transition to the unlocked configuration. In response to the lock command being generated, the lock is configured to transition to the locked configuration while maintaining access to the occupant portion of the body.

Another embodiment relates to a locking system for a recreational vehicle including an occupant portion and a storage compartment defining a storage volume. The locking system includes a portable device, a lock configured to selectively transition between a locked configuration and an unlocked configuration, wherein, in the locked configuration, access to the storage volume is inhibited, and, in the unlocked configuration, access to the storage volume is permitted, and one or more processing circuits configured to receive an unlock signal from the portable device, generate an unlock command based on the unlock signal, receive a lock signal from the portable device, and generate a lock command based on the lock signal. In response to the unlock command being generated, the lock is configured to transition to the unlocked configuration. In response to the lock command being generated, the lock is configured to transition to the locked configuration while maintaining access to the occupant portion of the recreational vehicle.

Still another embodiment relates to a recreational vehicle. The recreational vehicle includes a chassis, a tractive element coupled to the chassis, a prime mover configured to drive the tractive element to propel the recreational vehicle, a body coupled to the chassis and having an occupant portion, a storage compartment defining a storage volume, a lock configured to selectively transition between a locked configuration and an unlocked configuration, wherein, in the locked configuration, access to the storage volume is inhibited, and, in the unlocked configuration, access to the storage volume is permitted, and one or more processing circuits configured to receive an unlock signal, generate an unlock command based on the unlock signal, receive a lock signal, and generate a lock command based on the lock signal. In response to the unlock command being generated, the lock is configured to transition to the unlocked configuration. In response to the lock command being generated, the lock is configured to transition to the locked configuration while maintaining access to the occupant portion of the body. The lock signal includes at least one of (i) a proximity of a user device relative to the recreational vehicle, (ii) inertia data regarding inertia experienced by the recreational vehicle, or (iii) a location of the recreational vehicle relative to an area defined by a geofence.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a perspective view of the vehicle of FIG. 1 including at least one storage compartment, according to an exemplary embodiment.

FIG. 6 is a perspective view of the vehicle of FIG. 1 including at least one storage compartment, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

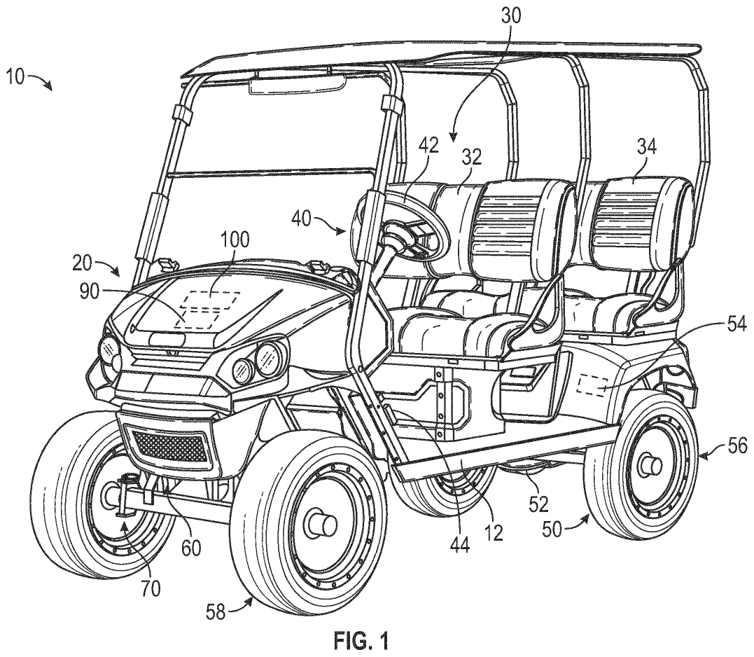

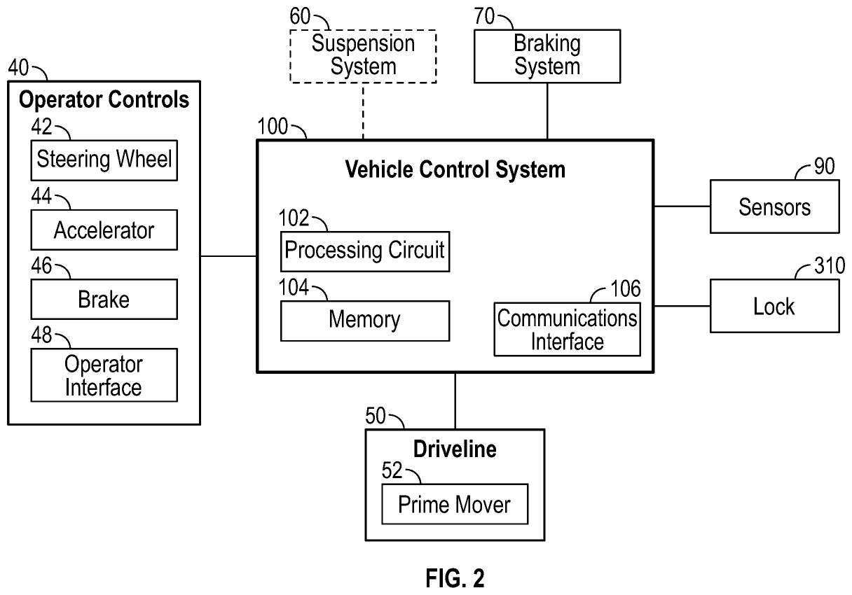

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

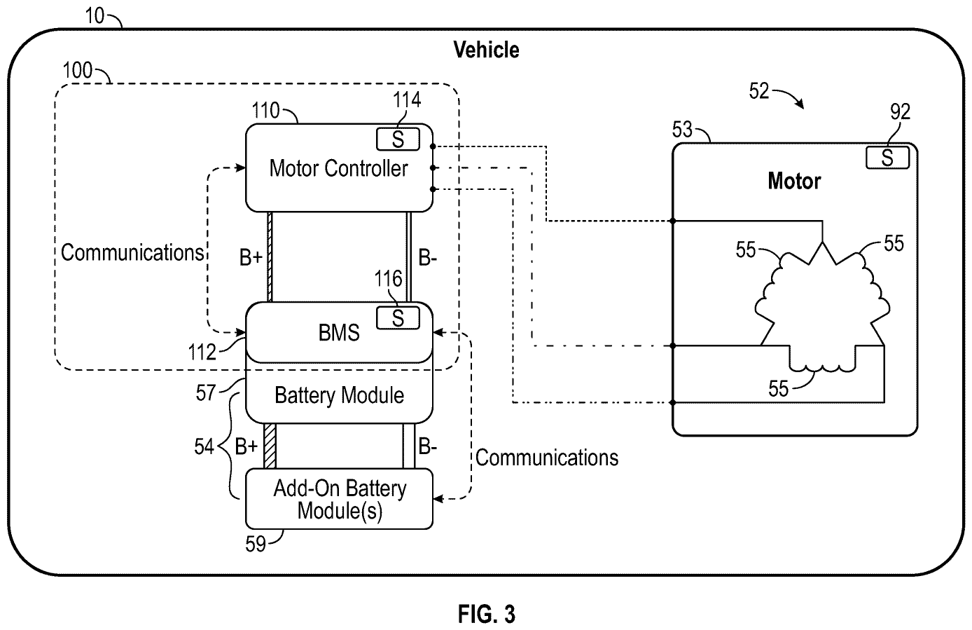

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

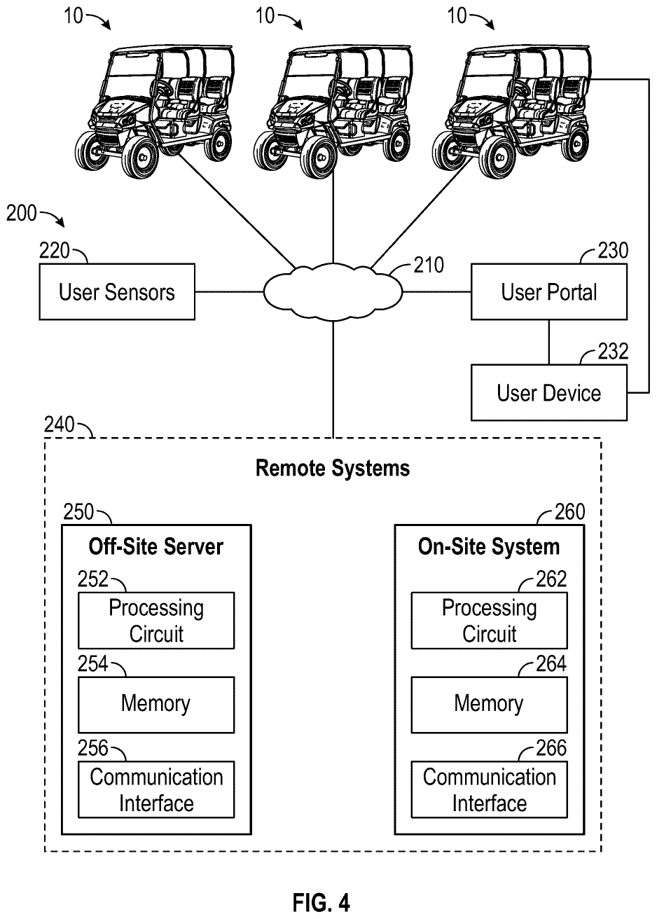

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may also be configured to facilitate operator control of one or more components of the vehicles 10 (e.g., the driveline 50, the suspension system 60, the braking system 70, the vehicle control system 100, the lock 310, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). Accordingly, the user device 232 may communicate with the vehicles 10 and the one or more components thereof through the one or more communication protocols via the network 210.

The user device 232 may include a display (e.g., a screen, etc.) configured to display one or more graphical user interfaces (“GUIs”) of the user portal 230. In some embodiments, the user device 232 is or includes a first initiator device (e.g., an electronic key, a key fob, an inductively charged device, a dedicated dongle, etc.) including an active power source such as a battery. In other embodiments, the user device 232 is or includes a second initiator device (e.g., a radio frequency identification (“RFID”) enabled device, card, or tag, near-field communication (“NFC”) enabled device, card, or tag, etc.) without an active power source. As shown in FIG. 4, the user device 232 is configured to communicate (i) with the remote systems 240 (e.g., using a first communication protocol, using the communications network 210, using a long-range communication protocol, cellular, Wi-Fi, radio, etc.) and (ii) with the vehicles 10 and the one or more components thereof (e.g., using a second communication protocol, using a short-range communication protocol, Bluetooth, Bluetooth low energy (“BLE”), NFC, RFID, etc.). The user device 232 may thereby function as an intermediary device that facilitates data transmissions between the remote systems 240 and the vehicles 10.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Locking Storage Compartment

As shown in FIGS. 2, 5, and 6, the vehicle 10 includes a storage system including at least one compartment (e.g., storage volume, glovebox, trunk, front trunk, etc.), shown as storage compartment 300, and at least one lock (e.g., locking mechanism, latch, deadbolt, etc.), shown as lock 310, coupled with the storage compartment 300. The storage compartment 300 defines a storage volume configured to receive and store items (e.g., personal items of the operator of the vehicle 10, information for the vehicle 10, spare components for the vehicle 10, etc.).

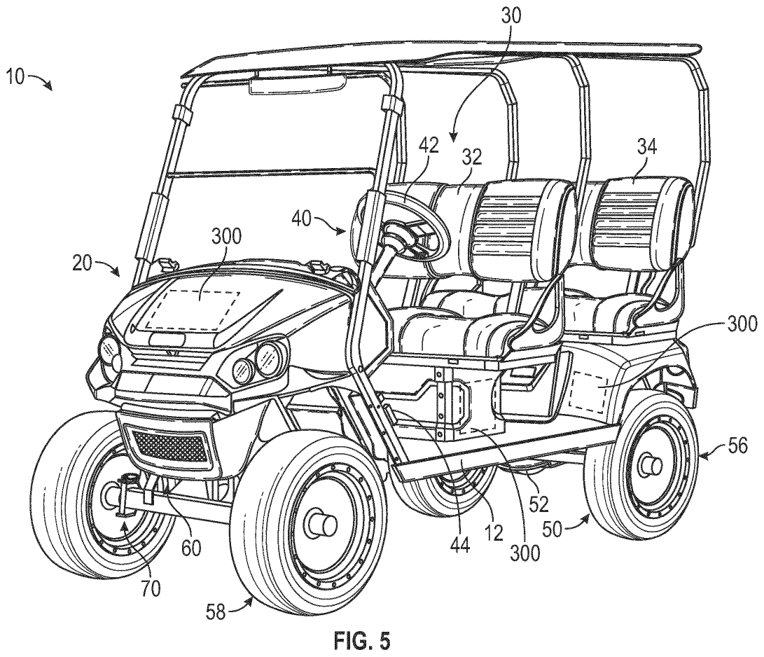

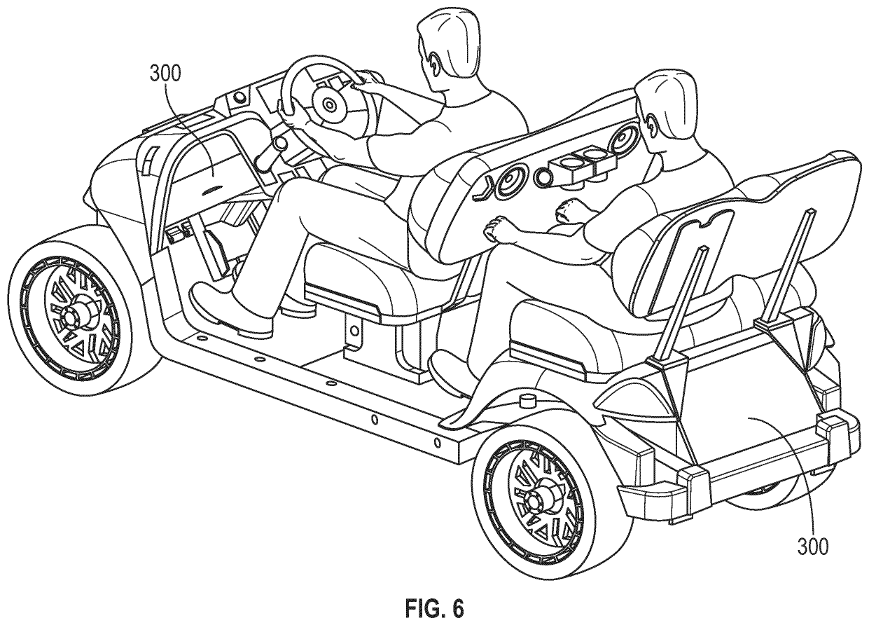

As shown in FIGS. 5 and 6, the storage compartment 300 is variously positioned about the vehicle 10. As shown in FIG. 5, the vehicle 10 includes a first storage compartment 300 positioned proximate a front end of the vehicle 10. The first storage compartment 300 is positioned such that the storage volume defined thereby is accessible by an operator positioned outside of the occupant seating area 30. In some embodiments, the storage compartment 300 is positioned under a hood (e.g., as a front trunk or “frunk”) of the vehicle 10 and the hood is moveable to provide selective access to the storage volume of the first storage compartment 300. In some embodiments, the vehicle 10 does not include the first storage compartment 300.

As shown in FIG. 5, the vehicle 10 includes a second storage compartment 300 positioned within the occupant seating area 30. The second storage compartment 300 may be positioned within a seat pedestal (e.g., a support structure) and beneath the front row seating 32 and/or beneath the rear row seating 34 such that the storage volume defined thereby is accessible by the operator positioned within the occupant seating area 30. In some embodiments, the front row seating 32 and/or the rear row seating 34 is movably coupled to the seat pedestal defining the second storage compartment 300. In such embodiments, moving the front row seating 32 and/or the rear row seating 34 provides selective access to the storage volume of the second storage compartment 300. In other embodiments, the second storage compartment 300 includes a door (e.g., lid, cover, etc.) movably coupled therewith to provide selective access to the storage volume of the second storage compartment 300. In still other embodiments, the second storage compartment 300 may include a movable drawer configured to slide out from beneath the front row seating 32 and/or beneath the rear row seating 34 to provide selective access to the storage volume of the second storage compartment 300. In some embodiments, the vehicle 10 includes both the first storage compartment 300 and the second storage compartment 300. In some embodiments, the vehicle 10 includes two or more second storage compartments 300 beneath the front row seating 32 and/or two or more second storage compartments 300 beneath the rear row seating 34. In other embodiments, the vehicle 10 does not include the second storage compartment 300.

As shown in FIG. 6, the vehicle 10 includes a third storage compartment 300 positioned within the occupant seating area 30. The third storage compartment 300 is positioned along a front end of the occupant seating area 30 proximate a driver's side (e.g., left side) thereof. The third storage compartment 300 is positioned such that the storage volume defined thereby is accessible by the operator (e.g., driver) sitting in a driver's seat. The third storage compartment 300 may be or include a glovebox including a door moveably coupled with a dash of the vehicle 10 to provide selective access to the storage volume. In some embodiments, the vehicle 10 additionally or alternatively includes a second third storage compartment 300 positioned within along the front end of the occupant seating area 30 proximate a passenger's side (e.g., right side) thereof. In some embodiments, the vehicle 10 includes the first storage compartment 300, the second storage compartment 300, and/or the third storage compartment 300. In other embodiments, the vehicle 10 does not include the third storage compartment 300.

As shown in FIG. 6, the vehicle 10 includes a fourth storage compartment 300 positioned proximate a rear end of the vehicle 10. The fourth storage compartment 300 is positioned such that the storage volume defined thereby is accessible by the operator positioned outside of the occupant seating area 30. The fourth storage compartment 300 may be or include a trunk (e.g., a rear trunk) including a door moveably coupled with the vehicle 10 to provide selective access to the storage volume. In some embodiments, the vehicle 10 includes the first storage compartment 300, the second storage compartment 300, the third storage compartment 300, and/or the fourth storage compartment 300. In other embodiments, the vehicle 10 does not include the fourth storage compartment 300. In some embodiments, the vehicle 10 includes one or more other storage compartments 300 variously positioned about the vehicle 10.

According to an exemplary embodiment, the lock 310 is configured to selectively transition between a locked state and an unlocked state to selectively lock and unlock the storage compartment 300. In the locked state, the lock 310 inhibits access to the storage compartment 300 (e.g., the storage volume of the storage compartment 300), and, in the unlocked state, the lock 310 permits access to the storage compartment 300. In some embodiments, the lock 310 includes a deadbolt configured to move between a locked position and an unlocked position to transition the lock 310 between the locked state and the unlocked state. In other embodiments, the lock 310 includes an electromagnetic mechanism (e.g., an electromagnet) configured to selectively magnetically lock the storage compartment 300. In still other embodiments, the lock 310 includes another suitable device configured to selectively lock the storage compartment 300. In some embodiments, each storage compartment 300 of the vehicle 10 is coupled with a respective lock 310 such that each storage compartment 300 is independently lockable and unlockable. In other embodiments, a single lock 310 is configured to selectively lock and unlock two or more storage compartments 300.

As shown in FIG. 2, the lock 310 is coupled with the vehicle 10 and configured to receive power to transition between the locked state and the unlocked state (e.g., via an electric actuator, motor, etc. thereof). In some embodiments, the lock 310 is electrically coupled with the energy storage 54 and configured to receive electrical energy therefrom to transition between the locked state and the unlocked state. In other embodiments, the lock 310 includes a power source (e.g., battery) configured to provide power to transition the lock 310 between the locked state and the unlocked state. In still other embodiments, the lock 310 does not include or is not coupled with an active power source. In such embodiments, the lock 310 may be configured to receive power (e.g., wireless power, inductive power, etc.) from an external device (e.g., the user device 232) in response to communication (e.g., inductive communication) with the external device to transition between the locked state and the unlocked state.

It should be understood that any of the functions or processes described herein with respect to the fleet monitoring and control system 200 may be performed by the vehicle control system 100, the user device 232, and/or the remote systems 240. By way of example, data collection may be performed by the vehicle control system 100 and data analytics may be performed by the vehicle control system 100. By way of another example, data collection may be performed by the vehicle control system 100 and data analytics may be performed by the user device 232 and/or the remote systems 240. By way of yet another example, data collection may be performed by the vehicle control system 100, a first portion of data analytics may be performed by the vehicle control system 100, a second portion of data analytics may be performed by the user device 232, and a third portion of the data analytics may be performed by the remote systems 240. By way of still another example, a first portion of data collection may be performed by the vehicle control system 100, a second portion of data collection may be performed by the user device 232 and/or the remote systems 240, and data analytics may be performed by the vehicle control system 100, the user device 232, and/or the remote systems 240.

According to an exemplary embodiment, when the user device 232 and the lock 310 are in communication, they may exchange data such as lock identifiers associated with the lock 310, user identifiers associated with a user, and user profiles including access credentials indicative of one or more locks 310 the user has access to. In some embodiments, as discussed in greater detail above, the user device 232 is communicably coupled with the remote systems 240 via a network, thereby functioning as an intermediary device that facilitates data transmissions between the remote systems 240 and the lock 310. The remote systems 240 may be configured to manage a plurality of access credentials or user profiles for a plurality of users that have access to at least one of the locks 310. The remote systems 240 may be configured to (i) generate and securely store lock identifiers, user identifiers, and user profiles and (ii) selectively provide control commands (e.g., authorization signals associated with a command to transition the lock 310 between the locked state and the unlocked state) to the user device 232 and the locks 310 based on the permissions of the user of the user device 232. In other embodiments, the vehicle control system 100 and/or the user device 232 may be configured to manage a plurality of access credentials or user profiles for a plurality of users that have access to at least one of the locks 310. In such embodiments, the vehicle control system 100 and/or the user device 232 may be configured to (i) generate and securely store lock identifiers, user identifiers, and user profiles and (ii) selectively provide control commands (e.g., authorization signals associated with a command to transition the lock 310 between the locked state and the unlocked state) to the locks 310 based on the permissions of the user of the user device 232.

According to an exemplary embodiment, in response to a control command (e.g., a lock command) being generated to transition the lock 310 from the unlocked state to the locked state, the lock 310 transitions to the locked state to inhibit access to the storage compartment 300 while maintaining access to the occupant seating area 30. In such an embodiment, while the lock 310 inhibits access to the storage compartment 300, the occupant seating area 30 remains accessible such that an operator can enter or exit the occupant seating area 30. Further, one or more other components of the vehicle 10 may operate without restrictions (e.g., operate normally) when the lock 310 is in the locked state. By way of example, the fleet monitoring and control system 200 may facilitate normal, unrestricted operation of the operator controls 40, the driveline 50, the suspension system 60, the braking system 70, etc. in response to the lock command being generated.

According to an exemplary embodiment, the fleet monitoring and control system 200 is configured to store a lock identifier, a lock key, and/or a manual access code for the lock 310. The lock identifier may uniquely identify the lock 310 from any other lock 310. In some embodiments, the lock identifier is provided to the lock 310 at the time of manufacturing. The identifier module may be configured to broadcast the lock identifier (e.g., in response to being in communication with the user device 232, etc.) to the vehicle control system 100, the user device 232, and/or the remote systems 240.

According to an exemplary embodiment, the communications network 210 is configured to facilitate wireless communication from and to the remote systems 240 (i) directly to and from the user device 232 and (ii) indirectly to and from at least one of the locks 310 through the user device 232. The remote systems 240 may communicate with the user device 232 directly or via an intermediate network (e.g., an internet network, a cellular network, etc.). In other embodiments, the communications interface 106 is configured to facilitate (i) direct wireless communication between the lock 310 and the remote systems 240 and (ii) indirect wireless communication between the user device 232 and the remote systems 240. By way of example, the user device 232 may not include long-range communication capabilities such that communication between the user device 232 and the remote systems 240 is facilitated by the lock 310 (or the vehicle 10) as an intermediary device.

According to an exemplary embodiment, the fleet monitoring and control system 200 is configured to manage a plurality of access credentials or user profiles for a plurality of users (e.g. operators) that have access to at least one of the locks 310. In some embodiments, the fleet monitoring and control system 200 includes various modules configured to (i) generate and securely store lock identifiers, user identifiers, and user profiles and (ii) selectively provide control commands (e.g., authorization signals associated with a command to transition the lock 310 between the locked state and the unlocked state) to the lock 310 based on the permissions of the users (e.g., clearance/authorization level, etc.) of the user device 232 and/or other possible factors.

According to an exemplary embodiment, the fleet monitoring and control system 200 includes a credential module and a permission module. The credential module may be configured to generate and securely store the lock identifiers (e.g., which may be provided to the locks 310 at the time of manufacturing, etc.). As an example, the credential module may include a first database of lock identifiers and may include the software configured to store and retrieve such lock identifiers from the first database. The credential module may be further configured to facilitate updating, replacing, and/or deleting the lock identifiers. The credential module may be further configured to generate and securely store the user identifiers (e.g., when a user is registered to a respective lock 310, etc.). The credential module may be further configured to generate and securely store the user profiles. The credential module may be further configured to facilitate updating, replacing, and/or deleting the user profiles (e.g., if a user's access is revoked, if a user identifier is updated, etc.). By way of example, the credential module may be configured to generate a user profile for a specific user and/or lock 310 when a new user is added to a respective lock 310. The user profiles may be associated with a user identifier associated with a specific user who has access to one or more locks 310. By way of example, the operator of a respective vehicle 10 may have access to each lock 310 on the respective vehicle 10. Each lock 310 accessible by the particular user is associated with a particular lock identifier, each of which may be included in the user profile. The user profiles may include audit data relating to operation of the one or more locks 310 that the user associated with the user profile is permitted to access (e.g., lock and unlock). By way of example, the audit data may include a timestamp (e.g., time, date, etc.) of when a particular lock 310 was locked or unlocked, a location (e.g., based on GPS data collected from the sensors 90 and/or the user sensors 220) of where a particular lock 310 was locked or unlocked, who (e.g., which operator, which user identifier, etc.) locked or unlocked a particular lock 310, a state (e.g., locked state or unlocked state) of a particular lock 310 that the user associated with the user profile is permitted to access.

The permission module may be configured to receive and store access permissions (e.g., access credentials) for users associated with one or more of the locks 310. The access permissions may include an authorization or clearance level of the user (e.g., administrator clearance, limited clearance, etc.) that defines which of the locks 310 the respective user is able to access and/or limit their access thereto. By way of example, a first user may only unlock or lock a respective lock 310 but not change the settings thereof, while a second user may unlock or lock the respective lock 310 and change the settings thereof. The permission module may be configured to facilitate updating the user profiles to include the lock identifiers associated with the respective locks 310 that the user (e.g., the user identifier) is authorized to access based on the access permissions stored on the permission module.

When attempting to access a lock 310 (e.g., transition the lock 310 between the locked state and the unlocked state), a user may bring the user device 232 in proximity to the lock 310 to bring the user device 232 in communication with the lock 310 (or the vehicle 10). When the user device 232 and the lock 310 (or the vehicle 10) are in communication, the communication protocol may be initiated between the lock 310 (or the vehicle 10) and the user device 232 to transmit data therebetween. In response to communication with the lock 310 (or the vehicle 10), the user device 232 may receive the lock identifier from the lock 310 (e.g., the lock identifier stored in the identifier module and uniquely associated with the particular lock 310 in communication with the user device 232). In some embodiments, the lock 310 (or the vehicle 10) transmits a signal associated with the state of the lock 310 (e.g., locked state or unlocked state). The user device 232 or the communications interface 106 may transmit a signal associated with the lock identifier and the state of the lock 310 to the remote systems 240. Additionally, the user device 232 or the communications interface 106 may transmit a signal associated with the user identifier uniquely associated with the particular user (e.g., a particular user profile, a particular user device 232, etc.).

In response to receiving the signal (e.g., from the user device 232, the communications interface 106, etc.), the access permissions of the permission module may be queried through to determine whether the user has the authorization to access the lock 310. By way of example, the access permissions may be queried through to match the received lock identifier with a list of lock identifiers associated with locks 310 that the received user identifier is authorized to access. If a match is found, a determination is made that the signal is valid and the user device 232 is authorized to access (e.g., lock/unlock) the lock 310. If no match is found, a determination is made that the user device 232 is unauthorized to access the lock 310.

In response to a determination that the user device 232 is authorized or unauthorized to access the lock 310, the fleet monitoring and control system 200 may generate a command signal and transmit the command signal to the lock 310 (or the vehicle 10) (e.g., indirectly via the user device 232, directly via the communications interface 106, etc.). If the command signal is associated with a determination that the user device 232 is authorized to access the lock 310, an unlock command is sent to the lock 310 to transition from the locked state to the unlocked state, or a lock command is sent to the lock 310 to transition from the unlocked state to the locked state. If the command signal is associated with a determination that the user device 232 is unauthorized to access the lock 310, the lock 310 does not transition between the locked and unlocked states.

It should be understood that the authentication scheme described herein is not meant to be limiting, but is provided as an example of one possible way to provide secure communication between the user device 232, the remote systems 240, and the lock 310 (or the vehicle 10). In other embodiments, secure communication is otherwise established using a different authentication scheme such as an authentication scheme that employs digital signatures, challenge-response procedures, multi-factor authentication (e.g., two-factor authentication, user profile plus a biometric, a user profile plus a PIN, etc.), and/or still other suitable authentication schemes.

According to an exemplary embodiment, the fleet monitoring and control system 200 is configured to automatically generate a control command (e.g., a lock command) to transition the lock 310 from the unlocked state to the locked state. In some embodiments, the lock command is generated based on a location of the vehicle 10. By way of example, in response to the location of the vehicle 10 indicating that the vehicle 10 is operating outside of a respective area (e.g., an area defined by a geofence), the fleet monitoring and control system 200 may generate the lock command to transition the lock 310 from the unlocked state to the locked state.

In some embodiments, the lock command is generated based on a proximity (e.g., location, distance, etc.) of the user device 232 (e.g., a user device 232 authorized to access the locks 310 and the storage compartments 300 of a respective vehicle 10) relative to the vehicle 10. In such embodiments, the proximity of the user device 232 relative to the vehicle 10 may be determined based on (i) a comparison between location data (e.g., GPS data, RTK data, etc.) acquired by the sensors 90 and location data acquired by one or more sensors of the user device 232, and/or (ii) a signal strength between the user device 232 and the vehicle 10. By way of example, the fleet monitoring and control system 200 may generate the lock command in response to determining the distance of the user device 232 is greater than a distance threshold from the vehicle 10. In such an example, the lock 310 may automatically transition to the locked state when the user with the user device 232 navigates (e.g., walks) away from the vehicle 10 (e.g., without locking the lock 310 before exceeding the distance threshold). Similarly, the fleet monitoring and control system 200 may generate the unlock command in response to determining the distance of the user device 232 is less than the distance threshold from the vehicle 10.

In some embodiments, the lock command is generated based on inertia data acquired by the sensors 90. The sensors 90 may include one or more IMU sensors configured to acquire inertia data regarding inertia experienced by the vehicle 10. Based on the inertia data, the fleet monitoring and control system 200 may determine a neutral inertia state indicative of the vehicle 10 being parked (e.g., not moving). In response to a determination that the vehicle 10 is in the neutral inertia state, the fleet monitoring and control system 200 may generate the lock command to transition the lock 310 to the locked state. Further, in response to a determination (e.g., based on the inertia data, location data, etc.) that the vehicle 10 is moving, the fleet monitoring and control system 200 may generate the lock command to transition the lock 310 to the locked state, thereby preventing an unintentional opening of the storage compartment 300 caused by the movement of the vehicle 10.

In some embodiments, the lock command is generated based on an elapsed time. In such embodiments, after the elapsed time (e.g., 10 seconds, 1 minute, 10 minutes, etc.), the fleet monitoring and control system 200 may generate the lock command to transition the lock 310 to the locked state. In some embodiments, the lock command is generated based movement of the vehicle 10 and the elapsed time. By way of example, the fleet monitoring and control system 200 may generate the lock command to transition the lock 310 to the locked state in response to the vehicle 10 not moving during the elapsed time. In some embodiments, the elapsed time is configurable by a user.

Regardless of how locking of the lock 310 is initiated, it should be understood that when and while the lock 310 is locked, a user maintains accessibility to the occupant seating area 30 and drivability of the vehicle 10 without needing to provide any sort of unlock command to the vehicle 10.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A recreational vehicle comprising:
a chassis;
a body coupled to the chassis and having an occupant portion;
a storage compartment defining a storage volume;
a lock configured to selectively transition between a locked configuration and an unlocked configuration, wherein, in the locked configuration, access to the storage volume is inhibited, and, in the unlocked configuration, access to the storage volume is permitted; and
one or more processing circuits configured to:
receive an unlock signal from an external device;
generate an unlock command based on the unlock signal;
receive a lock signal; and
generate a lock command based on the lock signal;
wherein, in response to the unlock command being generated, the lock is configured to transition to the unlocked configuration; and
wherein, in response to the lock command being generated, the lock is configured to transition to the locked configuration while maintaining access to the occupant portion of the body.

2. The recreational vehicle of claim 1, wherein the storage compartment includes at least one of a first storage compartment positioned proximate a front end of the recreational vehicle, a second storage compartment positioned within the occupant portion of the body, or a third storage compartment positioned proximate a rear end of the recreational vehicle.

3. The recreational vehicle of claim 2, wherein the storage compartment includes the first storage compartment, and wherein the first storage compartment is configured as a front trunk of the recreational vehicle.

4. The recreational vehicle of claim 2, wherein the storage compartment includes the second storage compartment, and wherein the second storage compartment is positioned along a dash of the recreational vehicle.

5. The recreational vehicle of claim 2, further comprising a seat disposed in the occupant portion and a pedestal configured to support the seat, wherein the storage compartment includes the second storage compartment, wherein the second storage compartment is positioned within the pedestal beneath the seat, and wherein, in the unlocked configuration, the second storage compartment is accessible by at least one of (i) moving the seat, (ii) moving a door of the second storage compartment, or (iii) sliding the second storage compartment out from beneath the seat.

6. The recreational vehicle of claim 2, wherein the storage compartment includes the third storage compartment, and wherein the third storage compartment is configured as a rear trunk of the recreational vehicle.

7. The recreational vehicle of claim 1, wherein the one or more processing circuits include at least one of (i) a first processing circuit located on the recreational vehicle or (ii) a second processing circuit located remote from the recreational vehicle.

8. The recreational vehicle of claim 1, wherein the external device includes a power source, and wherein the one or more processing circuits are configured to receive the unlock signal from the external device using a short-range communication protocol.

9. The recreational vehicle of claim 1, wherein the external device does not include a power source, and wherein the one or more processing circuits are configured to receive the unlock signal from the external device using a short-range communication protocol.

10. The recreational vehicle of claim 1, wherein the one or more processing circuits are configured to receive the unlock signal from the external device through a server using a long-range communication protocol.

11. The recreational vehicle of claim 1, wherein the one or more processing circuits are configured to determine a distance of the external device relative to the recreational vehicle based on a signal strength of the unlock signal or the lock signal.

12. The recreational vehicle of claim 11, wherein the one or more processing circuits are configured to generate the lock command in response to determining the distance of the external device relative to the recreational vehicle is greater than a distance threshold.

13. The recreational vehicle of claim 11, wherein the one or more processing circuits are configured to generate the unlock command in response to determining (i) the unlock signal is valid and (ii) the distance of the external device relative to the recreational vehicle is less than a distance threshold.

14. The recreational vehicle of claim 1, further comprising a sensor configured to acquire inertia data regarding inertia experienced by the recreational vehicle, wherein the lock signal includes the inertia data, and wherein the one or more processing circuits are configured to:
detect a neutral inertia state of the recreational vehicle based on the inertia data, the neutral inertia state being indicative of the recreational vehicle being parked; and
generate the lock command in response to detecting the neutral inertia state.

15. The recreational vehicle of claim 14, wherein the one or more processing circuits are configured to:
monitor an elapsed time; and
generate the lock command in response to detecting the neutral inertia state for the elapsed time.

16. The recreational vehicle of claim 1, wherein the lock signal includes location data regarding a location of the recreational vehicle, and wherein the one or more processing circuits are configured to:
monitor the location of the recreational vehicle relative to an area defined by a geofence based on the location data; and
generate the lock command when the location of the recreational vehicle indicates the recreational vehicle is operating outside of the area.

17. The recreational vehicle of claim 1, wherein the recreational vehicle is configured as a golf cart, an all-terrain vehicle, a utility task vehicle, a low speed vehicle, or a personal transport vehicle.

18. A locking system for a recreational vehicle including an occupant portion and a storage compartment defining a storage volume, the locking system comprising:
a portable device;
a lock configured to selectively transition between a locked configuration and an unlocked configuration, wherein, in the locked configuration, access to the storage volume is inhibited, and, in the unlocked configuration, access to the storage volume is permitted; and
one or more processing circuits configured to:
receive an unlock signal from the portable device;
generate an unlock command based on the unlock signal;
receive a lock signal from the portable device; and
generate a lock command based on the lock signal;
wherein, in response to the unlock command being generated, the lock is configured to transition to the unlocked configuration; and
wherein, in response to the lock command being generated, the lock is configured to transition to the locked configuration while maintaining access to the occupant portion of the recreational vehicle.

19. The locking system of claim 18, wherein the lock signal includes at least one of (i) a proximity of the portable device relative to the recreational vehicle, (ii) inertia data regarding inertia experienced by the recreational vehicle, or (iii) a location of the recreational vehicle relative to an area defined by a geofence.

20. A recreational vehicle comprising:
a chassis;
a tractive element coupled to the chassis;
a prime mover configured to drive the tractive element to propel the recreational vehicle;
a body coupled to the chassis and having an occupant portion;
a storage compartment defining a storage volume;
a lock configured to selectively transition between a locked configuration and an unlocked configuration, wherein, in the locked configuration, access to the storage volume is inhibited, and, in the unlocked configuration, access to the storage volume is permitted; and
one or more processing circuits configured to:
receive an unlock signal;
generate an unlock command based on the unlock signal;
receive a lock signal; and
generate a lock command based on the lock signal;
wherein, in response to the unlock command being generated, the lock is configured to transition to the unlocked configuration;
wherein, in response to the lock command being generated, the lock is configured to transition to the locked configuration while maintaining access to the occupant portion of the body; and
wherein the lock signal includes at least one of (i) a proximity of a user device relative to the recreational vehicle, (ii) inertia data regarding inertia experienced by the recreational vehicle, or (iii) a location of the recreational vehicle relative to an area defined by a geofence.
